(19) United States
(12) Patent Application Publication
(10) Pub. No.: US 2015/0337097 A1
(43) Pub. Date: Nov. 26, 2015

(54) POLYLACTIC ACID SHEET AND METHOD OF PRODUCING SAME

(71) Applicant: TORAY INDUSTRIES, INC., Tokyo (JP)

(72) Inventors: Yoichi Ishida, Otsu-shi (JP); Hideyuki Yamauchi, Otsu-shi (JP); Moriaki Arasaki, Otsu-shi (JP); Jun Sakamoto, Otsu-shi (JP)

(21) Appl. No.: 14/758,287

(22) PCT Filed: Dec. 24, 2013
(86) PCT No.: PCT/JP2013/084424

§ 371 Date: Jun. 29, 2015

(30) Foreign Application Priority Data
Jan. 7, 2013 (JP) 2013-000313
Mar. 18, 2013 (JP) 2013-054742
Jun. 4, 2013 (JP) 2013-117500

(51) Int. Cl. C08J 5/18; B32B 27/36; B32B 27/08

(52) U.S. Cl. CPC C08J 5/18; B32B 27/08; B32B 27/36; C08J 2367/04; C08J 2467/04; B32B 2250/244; B32B 2250/02; B32B 2307/306; B32B 2307/412; B32B 2307/738; B32B 2439/70

(57) ABSTRACT

A polylactic acid sheet has excellent formability, transparency, and heat resistance. The polylactic acid sheet includes a layer A mainly comprising a polylactic acid resin (the polylactic acid resin which is the main constituent of the layer A is hereinafter referred to as polylactic acid resin A), wherein the polylactic acid resin A has a melting point when measured under a condition of at least 190° C. and up to 230° C., and the polylactic acid resin A is non-oriented.

### TECHNICAL FIELD

This disclosure relates to a polylactic acid sheet having excellent formability, transparency, and heat resistance.

### BACKGROUND

Polylactic acid is a melt-formable polymer having excellent transparency and, since it has a characteristic feature of biodegradability, that resin has been developed as a biodegradable plastic which decomposes in natural environment after its use by being released as carbon dioxide gas, water, or the like. Recently, polylactic acid is also expected as a material capable of reducing the environmental burden by its carbon neutral property in view of the situation that the polylactic acid itself is prepared from a recyclable resource (biomass) generated from carbon dioxide, water, and the like and even if carbon dioxide is released into the environment after its use, the amount of the carbon dioxide in the global environment does not increase or decrease. In addition, production at a reduced cost of the lactic acid which is the monomer for polylactic acid by using a fermentation method using a microorganism has been started, and polylactic acid has become a candidate substitute for general-purpose petroleum plastics polymers. Compared to the petroleum plastics, however, polylactic acid is inferior in heat resistance and durability as well as in productivity due to the lower crystallization speed and, in the current situation, the range of practical use is very limited.

One item receiving attention to solve such a problem is use of a polylactic acid resin which forms a stereo complex. The polylactic acid resin which forms a stereocomplex is formed by mixing optically active poly-L-lactic acid and poly-D-lactic acid, and the melting point of the thus obtained polylactic acid resin reaches a temperature 50° C. higher than the melting point 170° C. of the polylactic acid homopolymer, namely, a melting point as high as 220° C. Accordingly, attempts are being conducted for application of polylactic acid resin for fibers, film sheets, and resin formed articles having high melting point and high crystallinity.

Sheets prepared by using a polylactic acid resin which forms stereocomplex had the problem of inferior thermal formability due to the rigid structure and its resulting high rigidity despite its realization of the excellent heat resistance. Accordingly, a sheet having excellent formability without sacrificing the excellent heat resistance is highly awaited.

Japanese Unexamined Patent Publication (Kokai) No. 2007-90550 discloses a film comprising a polylactic acid layer B which has a substantially non-oriented structure and polylactic acid layers A having an oriented structure disposed on opposite sides of layer B in contact with layer B.

Japanese Unexamined Patent Publication (Kokai) No. 2008-63502 discloses a formed body prepared by thermal forming a sheet comprising a polylactic acid composition containing a poly-L-lactic acid and a poly-D-lactic acid.

The disclosure in JP '550, however, suffers from the problem of inferior thermal formability due to its rigidity despite the improved heat resistance. The disclosure in JP '502 is utterly silent on improvement in formability.

It could therefore be helpful to provide a polylactic acid sheet exhibiting good formability while maintaining its heat resistance.

### SUMMARY

We thus provide:
(1) A polylactic acid sheet comprising a layer A mainly comprising a polylactic acid resin (the polylactic acid resin which is the main constituent of layer A is hereinafter referred to as polylactic acid resin A), wherein
   polylactic acid resin A has a melting point when measured under the following condition 1 of at least 190° C. and up to 230° C., and
   polylactic acid resin A is non-oriented;
Condition 1: in the measurement by DSC, first heating step is conducted by elevating temperature from 30° C. to 250° C. at a temperature elevation speed of 20° C./min and reducing the temperature to 30° C. at a temperature reducing speed of 20° C./min, second heating step is conducted by elevating temperature from 30° C. to 250° C. at a temperature elevation speed of 20° C./min, and the melting point is measured during this temperature elevation.
(2) A polylactic acid sheet according to (1) wherein polylactic acid resin A is a polylactic acid block copolymer constituted from a segment comprising a poly-L-lactic acid and a segment comprising a poly-D-lactic acid.
(3) A polylactic acid sheet according to (2) wherein the segment comprising the poly-L-lactic acid and the segment comprising the poly-D-lactic acid in the polylactic acid block copolymer are such that one segment has a weight average molecular weight of at least 60,000 to up to 300,000 and the other segment has a weight average molecular weight of at least 10,000 and up to 100,000.
(4) A polylactic acid sheet according to any one of (1) to (3) wherein layer A has a degree of crystallinity of at least 1% and up to 30% and a crystal size of at least 1 nm and up to 40 nm.
(5) A polylactic acid sheet according to any one of (1) to (4) comprising layer A and a layer B mainly comprising a polylactic acid resin (the polylactic acid resin which is the main constituent of layer B is hereinafter referred to as polylactic acid resin B), wherein
   polylactic acid resin B has a melting point when measured under the following condition 1 of less than 185° C. or no melting point:
Condition 1: in the measurement by DSC, first heating step is conducted by elevating temperature from 30° C. to 250° C. at a temperature elevation speed of 20° C./min and reducing the temperature to 30° C. at a temperature reducing speed of 20° C./min, second heating step is conducted by elevating temperature from 30° C. to 250° C. at a temperature elevation speed of 20° C./min, and the melting point is measured during this temperature elevation.
(6) A polylactic acid sheet according to (5) wherein layer A and layer B are directly laminated with no intervening layer.
(7) A polylactic acid sheet according to any one of (1) to (6) wherein the polylactic acid sheet contains at least one member selected from the group consisting of a polymer having a multi-layer constitution comprising a core layer and at least one shell layer covering the core layer; a polyether block copolymer constituted from a segment comprising a polyether and a segment comprising a polylactic acid; a polyester block copolymer constituted from a segment comprising a polyester and a segment comprising a polylactic acid; an aliphatic polyester other than the polylactic acid resin; and an aliphatic aromatic polyester.
(8) A method of producing a polylactic acid sheet of any one of (2) to (7) comprising the steps of mixing a poly-L-lactic acid and a poly-D-lactic acid in a biaxial extruder to prepare a mixture; preparing the polylactic acid block copolymer by solid phase polymerization of the mixture; and producing layer A by using the polylactic acid block copolymer.
(9) A method of producing a polylactic acid sheet according to any one of (1) to (8) further comprising the step of conducting a heat treatment at a temperature of at least 70° C.

We thus provide a polylactic acid sheet exhibiting good formability while maintaining its heat resistance.

### DETAILED DESCRIPTION

We provide a polylactic acid sheet which has a layer A mainly comprising a polylactic acid resin A which has a melting point measured by DSC of at least 190° C. and up to 230°, and which is non-oriented. In the DSC, first heating step is conducted by elevating the temperature from 30° C. to 250° C. at a temperature elevation speed of 20° C./min and reducing the temperature to 30° C. at a temperature reducing speed of 20° C./min, second heating step is conducted by elevating the temperature from 30° C. to 250° C. at a temperature elevation speed of 20° C./min, and the melting point is measured during this temperature elevation.

Next, our sheets and methods will be described in detail.

The polylactic acid resin is a polylactic acid resin wherein the lactic acid component constitutes at least 70% by mole and up to 100% by mole in 100% by mole of all monomer components constituting the polylactic acid resin.

The polylactic acid resin is not particularly limited while it is preferably a poly-L-lactic acid and/or a poly-D-lactic acid. The “poly-L-lactic acid” means that it contains at least 70% by mole and up to 100% by mole of the L-lactic acid component in 100% by mole of all lactic acid components in the polylactic acid resin. The “poly-D-lactic acid” means that it contains at least 70% by mole and up to 100% by mole of the D-lactic acid component in 100% by mole of all lactic acid components in the polylactic acid resin. However, the poly-L-lactic acid is preferably one containing at least 90% by mole and up to 100% by mole, more preferably one containing at least 95% by mole and up to 100% by mole, and still more preferably one containing at least 98% by mole and up to 100% by mole of the L-lactic acid component in 100% by mole of all lactic acid components in the polylactic acid resin; and the poly-D-lactic acid is preferably one containing at least 90% by mole and up to 100% by mole, more preferably one containing at least 95% by mole and up to 100% by mole, and still more preferably one containing at least 98% by mole and up to 100% by mole of the D-lactic acid component in 100% by mole of all lactic acid components in the polylactic acid resin.

The polylactic acid resin may also contain a component other than the lactic acid component (L-lactic acid component and the D-lactic acid component) to the extent not adversely affecting the performance. Exemplary such additional components include polycarboxylic acid, polyhydric alcohol, hydroxycarboxylic acid, and lactone, and more specifically, polycarboxylic acids including succinic acid, adipic acid, sebacic acid, fumaric acid, terephthalic acid, isophthalic acid, 2,6-naphthalene dicarboxylic acid, 5-sodium sulfoisophthalate, 5-tetrabutylphosphonium, and sulfoisophthalate, and their derivatives; polyhydric alcohols including ethylene glycol, propylene glycol, butanediol, pentanediol, hexanediol, octanediol, neopentyl glycol, glycerin, trimethylol propane, pentaerythritol, a polyhydric alcohol prepared by the addition of ethylene oxide or propylene oxide to trimethylolpropane or pentaerythritol, an aromatic polyhydric alcohol prepared by the addition of ethylene oxide to bisphenol, diethylene glycol, triethylene glycol, polyethylene glycol, and polypropylene glycol, and their derivatives; hydroxycarboxylic acids including glycolic acid, 3-hydroxybutyric acid, 4-hydroxybutyric acid, 4-hydroxyvaleric acid, and 6-hydroxycaproic acid; lactones including glycolide, ε-caprolactone glycolide, ε-caprolactone, β-propiolactone, δ-butyrolactone, β- or γ-butyrolactone, pivalolactone, and δ-valerolactone.

The polylactic acid resin is not particularly limited for its weight average molecular weight. The weight average molecular weight, however, is preferably at least 100,000 and up to 300,000 in view of formability and mechanical and physical properties. More preferably, the weight average molecular weight is at least 120,000 and up to 280,000, and still more preferably at least 130,000 and up to 270,000, and most preferably at least 140,000 and up to 260,000.

In view of the heat resistance of the resulting sheet, it is important that polylactic acid resin A which is the main constituent of layer A in the polylactic acid sheet has a melting point as measured under Condition 1 of at least 190° C. and less than 230° C. The melting point of polylactic acid resin A is preferably at least 200° C. and less than 230° C., more preferably at least 205° C. and less than 230° C., and still more preferably at least 210° C. and less than 230° C.
Condition 1: In the measurement by DSC, first heating step is conducted by elevating temperature from 30° C. to 250° C. at a temperature elevation speed of 20° C./min and reducing the temperature to 30° C. at a temperature reducing speed of 20° C./min, second heating step is conducted by elevating temperature from 30° C. to 250° C. at a temperature elevation speed of 20° C./min, and the melting point is measured during this temperature elevation.

While polylactic acid resin A has a melting point measured under Condition 1 of at least 190° C. and less than 230° C., it may also have a melting point of at least 150° C. and less than 185° C. which corresponds the single crystal derived from the poly-L-lactic acid and the single crystal derived from the poly-D-lactic acid. The “melting point of polylactic acid resin A measured under Condition 1” is a value determined for the starting material of layer A of the polylactic acid sheet. When two or more polylactic acid resins A are used as the starting material of layer A, a melting point outside the range of at least 190° C. and less than 230° C. may be measured as long as polylactic acid resin A with the measurement of the melting point of at least 190° C. and less than 230° C. is included.

As described above, layer A is a layer mainly comprising polylactic acid resin A. The “mainly comprising polylactic acid resin A” as used herein means that polylactic acid resin A constitutes at least 50% by weight and up to 100% by weight in 100% by weight of all components of layer A.

More specifically, in view of heat resistance and formability of the resulting sheet, content of polylactic acid resin A in layer A is preferably at least 60% by weight and up to 100% by weight, more preferably at least 70% by weight and up to 100% by weight, and still more preferably at least 80% by weight and up to 100% by weight in relation to 100% by weight of the entire components of layer A.

As described above, it is important that polylactic acid resin A has a melting point as measured under Condition 1 of at least 190° C. and less than 230° C. While the method used to control the melting point within such range is not particularly limited, polylactic acid resin A is preferably one prepared by A) or B):
A) a mixture of a poly-L-lactic acid and a poly-D-lactic acid for polylactic acid resin A,
B) a polylactic acid block copolymer constituted from the segment comprising a poly-L-lactic acid and a segment comprising a poly-D-lactic acid for polylactic acid resin A.

In view of realizing the melting point of polylactic acid resin A as measured under Condition 1 of at least 190° C. and less than 230° C., both methods A) and B) are preferable. However, in consideration of realizing higher transparency and heat resistance of the resulting sheet, preferred is method B), namely, use of a polylactic acid block copolymer for polylactic acid resin A. Accordingly, method B) is described below.

When a polylactic acid block copolymer is used for polylactic acid resin A, the polylactic acid block copolymer is constituted from a segment comprising a poly-L-lactic acid and a segment comprising a poly-D-lactic acid. While the segment comprising a poly-L-lactic acid and the segment comprising a poly-D-lactic acid are not particularly limited for their weight average molecular weight, it is preferable that one of the segment comprising a poly-L-lactic acid and the segment comprising a poly-D-lactic acid in the polylactic acid block copolymer preferably has a weight average molecular weight of at least 60,000 and up to 300,000 and the other segment has a weight average molecular weight of at least 10,000 and up to 100,000. More preferably, for the weight average molecular weight of the segment comprising a poly-L-lactic acid and the segment comprising a poly-D-lactic acid in the polylactic acid block copolymer, one of a segment comprising a poly-L-lactic acid and a segment comprising a poly-D-lactic acid in the polylactic acid block copolymer preferably has a weight average molecular weight of at least 60,000 and up to 300,000 and the other segment has a weight average molecular weight of at least 10,000 and up to 50,000. Still more preferably, for the weight average molecular weight of the segment comprising a poly-L-lactic acid and the segment comprising a poly-D-lactic acid in the polylactic acid block copolymer, one segment has a weight average molecular weight of at least 100,000 and up to 270,000 and the other segment has a weight average molecular weight of at least 20,000 and up to 40,000. Even more preferably, one segment has a weight average molecular weight of at least 150,000 and up to 240,000 and the other segment has a weight average molecular weight of at least 30,000 and up to 40,000.

When method A), namely, a mixture of the poly-L-lactic acid and the poly-D-lactic acid is used for polylactic acid resin A, the weight ratio of the poly-L-lactic acid to the poly-D-lactic acid is preferably 80:20 to 20:80, more preferably 75:25 to 25:75, still more preferably 70:30 to 30:70, and most preferably 60:40 to 40:60. When the weight ratio of each of the poly-L-lactic acid and the poly-D-lactic acid is 80:20 to 20:80, stereocomplex formation of polylactic acid resin A is facilitated, and an increase in the melting point of the polylactic acid resin will be sufficient, and this in turn means that the melting point of polylactic acid resin A measured under Condition 1 will be at least 190° C. and less than 230° C.

When method B) is used, namely, when a polylactic acid block copolymer constituted from the segment comprising a poly-L-lactic acid and the segment comprising a poly-D-lactic acid is used for polylactic acid resin A, the weight ratio of the segment comprising a poly-L-lactic acid and the segment comprising a poly-D-lactic acid is preferably 80:20 to 20:80, more preferably 75:25 to 25:75, still more preferably 70:30 to 30:70, and most preferably 60:40 to 40:60. When the weight ratio of each of the segment comprising a poly-L-lactic acid and the segment comprising a poly-D-lactic acid is in the range of 80:20 to 20:80, stereocomplex formation of polylactic acid resin A is facilitated, and increase in the melting point of the polylactic acid resin will be sufficient, and this in turn means that the melting point of polylactic acid resin A measured under Condition 1 will be at least 190° C. and less than 230° C.

An exemplary method of preparing the mixture of the poly-L-lactic acid and the poly-D-lactic acid used in method A) is melt kneading the poly-L-lactic acid and the poly-D-lactic acid, and the method used for melt kneading is not particularly limited. Exemplary methods include a method wherein the poly-L-lactic acid and the poly-D-lactic acid are melt kneaded at a temperature not lower than the melt ending temperature of the component having a higher melting point; a method wherein the components are mixed in a solvent and the solvent is thereafter removed; and a method wherein at least one of the poly-L-lactic acid and the poly-D-lactic acid in molten state is preliminarily resided in a melting apparatus at a temperature of 50° C. lower than the melting point to 20° C. higher than the melting point while applying shear force, and mixing of the poly-L-lactic acid and the poly-D-lactic is conducted so that crystals of the mixture comprising the poly-L-lactic acid and the poly-D-lactic acid will remain in the resulting product. Exemplary methods used for the melt kneading of the poly-L-lactic acid and the poly-D-lactic acid at a temperature not lower than the melt ending temperature include mixing the poly-L-lactic acid and the poly-D-lactic acid in a batchwise or continuous process, and either method may be used by using a kneading apparatus such as monoaxial extruder, biaxial extruder, plasto mill, kneader, and stirred-tank reactor equipped with a vacuum pump. In view of uniformly and fully kneading the mixture, preferred is a biaxial extruder.

An exemplary method of preparing the polylactic acid block copolymer used in method B) is not particularly limited, and any method commonly used in producing the polylactic acid can be used. Exemplary such methods include a method wherein the poly-L-lactic acid and the poly-D-lactic acid are mixed in a biaxial extruder to prepare a mixture and the mixture is subjected to solid phase polymerization to thereby produce the polylactic acid block copolymer; a lactide method wherein ring-opening polymerization of one of the L-lactide and D-lactide which are cyclic dimers produced from the starting lactic acid component is conducted in the presence of a catalyst, and further ring-opening polymerization is promoted by adding the lactide which is the optical isomer of the polylactic acid to produce the polylactic acid block copolymer; a method wherein melt kneading of the poly-L-lactic acid and the poly-D-lactic acid is conducted for a prolonged period at a temperature not lower than the melt ending temperature of the component having a higher melting point to promote ester exchange reaction between the segment of the L-lactic acid component and the segment of the D-lactic acid component to thereby produce the polylactic acid block copolymer; and a method wherein the poly-L-lactic acid and the poly-D-lactic acid are covalently bonded with a polyfunctional compound by adding a polyfunctional compound to the reaction of the poly-L-lactic acid and the poly-D-lactic acid to thereby produce the polylactic acid block copolymer. While any of such methods may be used in producing the polylactic acid block copolymer, preferred is a method comprising the steps of mixing a poly-L-lactic acid and a poly-D-lactic acid in a biaxial extruder to produce a mixture, conducting the solid phase polymerization of the mixture to produce the polylactic acid block copolymer, and producing layer A by using the polylactic acid block copolymer since the resulting sheet will be provided with improved heat resistance and transparency.

The degree of crystallinity of layer A is preferably at least 1% and up to 30%. When the degree of crystallinity of layer A is in the range of 1% and up to 30%, the sheet will have a high heat resistance and, since the crystals function as pseudo-crosslinking points, the sheet will exhibit high formability in a wide range of temperature. More preferably, layer A may have a degree of crystallinity of at least 3% and up to 25%, and still more preferably, at least 5% and up to 20%. The degree of crystallinity of layer A is the one measured by the procedure described in the Examples.

A preferable method used to regulate the degree of crystallinity of layer A of the polylactic acid sheet to at least 1% and up to 30% is inclusion of a heat treatment step at a temperature of at least 70° C. in production of the sheet having layer A. When the heat treatment temperature is lower than 70° C., crystallization will not be sufficiently promoted and layer A may not exhibit a degree of crystallinity of at least 1%.

The crystal size of layer A is preferably at least 1 nm and up to 40 nm. The crystal size of layer A is the one obtained by the measurement described in the Example.

When formability is featured, crystal size of layer A is preferably at least 1 nm and up to 30 nm. The crystal size of layer A when formability is featured is more preferably at least 3 nm and up to 28 nm, and still more preferably at least 5 nm and up to 25 nm. When the crystal size of layer A is less than 1 nm, the crystals may not fully function as the pseudo-crosslinking points, and a crystal size in excess of 30 nm may require high stress for crystal deformation, adversely affecting formability.

A preferable method used to regulate the crystal size of layer A in the polylactic acid sheet to at least 1 nm and up to 30 nm is incorporation of a heat treatment step at a temperature of at least 80° C. and up to 150° C. in the production of the sheet having layer A. When the heat treatment temperature is less than 80° C., the crystal size may not be regulated to at least 1 nm while a heat treatment temperature in excess of 150° C. may result in a crystal size in excess of 30 nm which results in insufficient formability.

When chemical resistance is featured, layer A may have a crystal size of at least 15 nm and up to 40 nm. The crystal size of layer A when the chemical resistance is featured is more preferably at least 22 nm and up to 35 nm, and still more preferably at least 24 nm and up to 33 nm.

A preferable method used to regulate the crystal size of layer A in the polylactic acid sheet to at least 15 nm and up to 40 nm is incorporation of a heat treatment step at a temperature of at least 90° C. and up to 175° C. in production of the sheet having layer A. A more preferable method is incorporation of a heat treatment step at a temperature of at least 130° C. and up to 170° C. in the production of the sheet having layer A. When the heat treatment temperature is less than 90° C., the crystal size may not be regulated to at least 15 nm while the heat treatment temperature in excess of 175° C. may result in the crystal size in excess of 40 nm which results in the insufficient chemical resistance.

Our polylactic acid sheets comprise a layer A mainly comprising a polylactic acid resin A, wherein polylactic acid resin A has a melting point when measured under Condition 1 of at least 190° C. and up to 230° C., and wherein polylactic acid resin A is non-oriented. More preferably, our polylactic acid sheets have a laminate constitution comprising layer A and a layer B mainly comprising a polylactic acid (the polylactic acid resin which is the main constituent of layer B is hereinafter referred to as polylactic acid resin B), wherein polylactic acid resin B has a melting point when measured under Condition 1 of less than 185° C. or no melting point. Next, the polylactic acid sheet having layer B which is a more preferable aspect is described.

In the polylactic acid sheet having a laminate structure, it is important that the sheet has a layer B mainly comprising a polylactic acid resin B in addition to layer A as described above. The “mainly comprising polylactic acid resin B” as used herein means that polylactic acid resin B constitutes at least 50% by weight and up to 100% by weight in 100% by weight of all components of layer B.

As described above, the polylactic acid sheet having a laminate structure has a layer B mainly comprising polylactic acid resin B. To provide a favorable formability with the sheet, it is important that polylactic acid resin B in layer B has a melting point when measured under Condition 1 of less than 185° C. or no melting point. When polylactic acid resin B exhibits a melting point, the melting point is preferably at least 120° C. and less than 185° C., more preferably at least 135° C. and less than 180° C., and still more preferably at least 150° C. and less than 175° C. The “melting point of polylactic acid resin B measured under Condition 1” is the value determined for the starting material of layer B of the polylactic acid sheet. When two or more polylactic acid resins B are used as the starting material of layer B, a melting point more than 185° C. may be measured as long as polylactic acid resin B with the measurement of the melting point of less than 185° C. or the polylactic acid exhibiting no melting point is included.

To produce polylactic acid resin B exhibiting a melting point of less than 185° C. or no melting point, use of polylactic acid resin C) and/or polylactic acid resin D) as described below as polylactic acid resin B is preferable:
C) a polylactic acid resin wherein molar ratio of the D-lactic acid component to the L-lactic acid component is 10:90 to 15:85 (hereinafter referred to as polylactic acid resin B1)
D) a polylactic acid resin wherein molar ratio of the D-lactic acid component to the L-lactic acid component is 0.2:100 to 9.9:89.9 (hereinafter referred to as polylactic acid resin B2).

The proportional ratio of polylactic acid resin B1 and polylactic acid resin B2 in layer B may be adjusted depending on the intended application and properties of the sheet.

To improve transparency of the resulting sheet, a higher content of polylactic acid resin B1 in polylactic acid resin B is preferable. More specifically, the content of polylactic acid resin B1 is preferably at least 50% by weight and up to 100% by weight, more preferably at least 60% by weight and up to 100% by weight, and still more preferably at least 70% by weight and up to 100% by weight in relation to 100% by weight of all component in polylactic acid resin B in layer B. Preferably, polylactic acid resin B1 is one having a molar ratio of the D-lactic acid component to the L-lactic acid component in the polylactic acid resin of 10.5:89.5 to 14:86, more preferably 11:89 to 13:87.

To improve the heat resistance and mechanical properties of the resulting sheet, a higher content of polylactic acid resin B2 in polylactic acid resin B is preferable. More specifically, the content of polylactic acid resin B2 is preferably at least 50% by weight and up to 100% by weight, more preferably at least 60% by weight and up to 100% by weight, and still more preferably at least 70% by weight and up to 100% by weight in relation to 100% by weight of all component in polylactic acid resin B in layer B. While polylactic acid resin B2 may be the one solely containing the L-lactic acid component, a more preferable molar ratio of the D-lactic acid component to the L-lactic acid component in polylactic acid resin B2 is 1:99 to 5:95, and more preferably 2:98 to 4:96.

The polylactic acid sheet having a laminate structure is not particularly limited as long as the sheet has both layer A and layer B and the merits of the sheet is not adversely affected. Layer A and layer B may have an intervening layer of other resin or an intervening adhesive layer. Examples of the laminate include layer B/layer A and layer B/layer A/layer B. In consideration of sheet transparency and formability, the polylactic acid sheet having a laminate structure is preferably an example wherein layer A and layer B are directly laminated without other layer.

The thickness of the polylactic acid sheet, namely, the thickness of the polylactic acid sheet without layer B and the thickness of the polylactic acid sheet having a laminate structure containing layer A and layer B is not particularly limited. The thickness, however, is preferably at least 50 μm and up to 2000 μm, more preferably 100 to 1500 μm, and still more preferably 200 to 750 μm.

The polylactic acid sheet having a laminate structure is not particularly limited for its layer thickness ratio. In view of formability of the sheet, however, “thickness of layer A”/“total of the thickness of layer(s) B” ratio is preferably 1/15 to 20/1, more preferably 1/15 to 6/1, and still more preferably 1/5 to 2/1. The “total of the thickness of layer(s) B” is the thickness of layer B when only one layer B is present, and it is the sum of the thickness of two or more layers B when two or more layers B are present.

Irrespective of whether the polylactic acid sheet has a structure without layer B or a structure with both layers A and B, it is important that it is not oriented (non-oriented) in view of providing good formability. Whether the polylactic acid sheet is non-oriented or not can be determined by degree of surface orientation ΔP. More specifically, the degree of surface orientation ΔP of at least 0 and up to 0.002 corresponds to the non-oriented state of the polylactic acid sheet. The procedure of measuring the degree of surface orientation ΔP will be described later.

The polylactic acid sheet may also contain various additives to the extent that they do not adversely affect the sheet.

Exemplary additives which may be incorporated in the polylactic acid sheet include filler (glass fiber, carbon fiber, metal fiber, natural fiber, organic fiber, glass flakes, glass beads, ceramic fiber, ceramic beads, asbestos, wollastonite, talc, clay, mica, sericite, zeolite, bentonite, montmorillonite, synthetic mica, dolomite, kaolin, silicic acid powder, feldspar powder, potassium titanate, shirasu balloons, calcium carbonate, magnesium carbonate, barium sulfate, calcium oxide, aluminum oxide, titanium oxide, silicic acid aluminum, silicon oxide, gypsum, novaculite, dowsonite, white clay and the like), UV absorbent (resorcinol, salicilate, benzotriazole, benzophenone and the like), thermal stabilizer (hindered phenol, hydroquinone, phosphite, substituted derivatives thereof and the like), lubricant, releasing agent (montanic acid and salts, esters, and half ester thereof, stearyl alcohol, stearamid, polyethylene wax and the like), colorants including dye (nigrosine and the like) and pigment (cadmium sulfide, phthalocyanine and the like), anti-coloring agent (phosphite, hypophosphite and the like), flame retardant (red phosphorus, phosphate ester, bromated polystyrene, bromated polyphenylene ether, bromated polycarbonate, magnesium hydroxide, melamine, cyanuric acid and salts thereof, silicon compound and the like), electroconductive or colorant (carbon black and the like), slidability-improving agent (graphite, fluororesin and the like), and antistatic agent, which may be incorporated alone or in combination of two or more.

The polylactic acid sheet may also contain one or more crystal nucleating agents to the extent not adversely affecting the sheet. Examples of the crystal nucleating agent preferable for use in the polylactic acid sheet include inorganic nucleating agents such as talc, organic amide compounds such as ethylene bislauramide, ethylene bis-12-dihydroxystearamide, and trimesic tricyclohexylamide, pigment nucleating agents such as copper phthalocyanine and pigment yellow 110, organic metal carboxylate, and zinc phenylphosphonate.

To improve formability, the polylactic acid sheet preferably contains at least one member selected from the group consisting of polymer having a multi-layer structure constituted from a core layer and at least one shell layer covering the core layer, polyether block copolymer constituted from a segment comprising a polyether and a segment comprising a polylactic acid, polyester block copolymer constituted from a segment comprising a polyester and a segment comprising a polylactic acid, aliphatic polyester other than a polylactic acid resin, and aliphatic aromatic polyester (which is hereinafter referred to as the formability-improving agent). Total content of all formability-improving agents in the polylactic acid sheet is preferably at least 4% by weight and up to 20% by weight in relation to 100% by weight of all components in the polylactic acid sheet.

The formability-improving agent as described above may also be used in combination of two or more to the extent not adversely affecting the merits of the sheet. When the total content of the formability-improving agents in the polylactic acid sheet is less than 4% by weight, the formability-improving effects may not be sufficiently realized, while incorporation in excess of 20% by weight may result in the loss of film-formation stability, sheet flatness, as well as handling convenience in the post-production process such as printing.

The “polymer having a multi-layer structure constituted from a core layer and at least one shell layer covering the core layer” which is an exemplary formability-improving agent is a polymer having a so-called “core-shell” structure constituted from the innermost layer (core layer) and at least one layer (shell layer) covering the core layer wherein the adjacent layers are respectively constituted from different type of polymers. While the number of layers constituting the polymer having a multi-layer constitution (including the core layer) is not particularly limited as long as the merits of the sheet are not adversely affected, the number of layers is preferably at least 1 layer and up to 5 layers, more preferably at least 1 layer and up to 4 layers, and still more preferably at least 1 layer and up to 3 layers to improve formability.

The rubber layer is layer constituted from a polymer component having rubber elasticity. The type of the rubber layer is not particularly limited and the rubber elasticity is the elasticity realized by the expansion and contraction of the polymer chain.

To improve formability without sacrificing transparency, the polymer having a multi-layer structure used for the formability-improving agent is preferably a core-shell type acryl polymer.

Exemplary rubber layer of the polymer having a multi-layer constitution include a rubber constituted from a polymerization product of acryl component, silicone component, styrene component, nitrile component, conjugated diene component, urethane component, or ethylene propylene component.

The polymer components preferable for the rubber layer include the rubbers constituted from the polymerization product of acryl components such as ethyl acrylate and butyl acrylate, silicone components such as dimethylsiloxane and phenylmethylsiloxane, styrene components such as styrene and α-methylstyrene, nitrile components such as acrylonitrile and meth-acrylonitrile, and conjugated diene components such as butadiene and isoprene. Also preferred are the rubber constituted from the copolymerization product of two or more of the components as described above, and exemplary such rubbers include (1) a rubber constituted from the copolymerization product of an acryl component such as ethyl acrylate or butyl acrylate and a silicone component such as dimethylsiloxane or phenyl methylsiloxane, (2) a rubber constituted from the copolymerization product of an acryl component such as ethyl acrylate or butyl acrylate and a styrene component such as styrene or α-methylstyrene, (3) a rubber constituted from the copolymerization product of an acryl component such as ethyl acrylate or butyl acrylate and a conjugated diene component such as butadiene and isoprene, and (4) a rubber constituted from the copolymerization product of an acryl component such as ethyl acrylate or butyl acrylate, a silicone component such as dimethylsiloxane or phenylmethylsiloxane, and a styrene component such as styrene or α-methylstyrene. In addition, also preferred is use of a rubber prepared by copolymerizing crosslinkable components such as divinylbenzene, allyl acrylate, and butylene glycol diacrylate and crosslinking the thus obtained copolymer.

Exemplary preferable polymers having a multi-layer constitution are polymers having a multi-layer constitution comprising a core layer and one shell layer, and examples include a polymer having a multi-layer constitution wherein the core layer is a rubber layer containing the component prepared by copolymerizing dimethylsiloxane and butyl acrylate and the shell layer comprises methyl methacrylate polymer; a polymer having a multi-layer constitution wherein the core layer is a rubber layer containing the component prepared by copolymerizing butadiene and styrene, and the shell layer is methyl methacrylate polymer; and a polymer having a multi-layer constitution wherein the core layer is a rubber layer containing the component prepared by polymerizing butyl acrylate, and the shell layer is methyl methacrylate polymer. The rubber layer most preferably comprises a polymer containing glycidyl methacrylate.

Next, the polyether block copolymer constituted from a segment comprising a polyether and a segment comprising a polylactic acid and the polyester block copolymer constituted from a segment comprising a polyester and a segment comprising a polylactic acid which are typical formability-improving agents are described. (These are hereinafter referred to as the “block copolymer plastic agents.”)

The weight proportion of the segment comprising polylactic acid in the block copolymer plastic agent is preferably up to 50% by weight of the entire block copolymer plastic agent in consideration of providing the desired formability even by addition of a smaller amount of the plastic agent while incorporation of at least 5% by weight is preferable in view of suppressing bleed out. The segment comprising polylactic acid in one molecule of the block copolymer plastic agent may preferably have a number average molecular weight of at least 1,200 and up to 10,000. When the segment comprising polylactic acid in the block copolymer plastic agent has the number average molecular weight of at least 1,200, sufficient affinity will be generated between the block copolymer plastic agent and the polylactic acid resin, and the segment will be partly incorporated in the crystals formed from the polylactic acid to form a so-called “eutectic mixture.” The action of anchoring the block copolymer plastic agent to the polylactic resin is thereby developed, and this has great influence in suppressing bleed out of the block copolymer plastic agent. The segment comprising polylactic acid in the block copolymer plastic agent may preferably have a number average molecular weight of at least 1,500 and up to 6,000, and more preferably at least 2,000 and up to 5,000. In view of suppressing the bleed out, the segment comprising polylactic acid in the block copolymer plastic agent is preferably either a segment wherein the L-lactic acid component constitutes at least 95% by mole and up to 100% by mole or the segment wherein the D-lactic acid component constitutes at least 95% by mole and up to 100% by mole.

While the block copolymer plastic agent has at least a segment comprising a polyether or a segment comprising a polyester, use of the block copolymer having a segment comprising a polyether and a segment comprising polylactic acid is more preferable since such block copolymer is capable of providing the desired formability by addition of a small amount. In addition, the block copolymer constituted from the segment comprising a polyether and the segment comprising polylactic acid is preferably the one wherein the segment comprising a polyether is a segment comprising polyalkylene ether in view of the capability of providing the intended formability by addition of a small amount. Exemplary segments comprising a polyether include segments comprising polyethylene glycol, polypropylene glycol, polytetramethylene glycol, polyethylene glycol-polypropylene glycol copolymer, or the like. Of these, the most preferred is a segment comprising polyethylene glycol due to the high affinity with the polylactic acid resin, and hence, due to the excellent improvement efficiency, and in particular, in view of the capability of imparting the desired formability by addition of a small amount of the block copolymer plastic agent.

When the block copolymer plastic agent has a segment comprising the polyester, preferable such segments comprising the polyester include the polyester comprising an aliphatic diol such as polyglycolic acid, poly(3-hydroxy butylate), poly(3-hydroxy butylate-3-hydroxyvalerate), polycaprolactone, or ethyleneglycol, propane diol, or butanediol and an aliphatic dicarboxylic acid such as succinic acid, sebacic acid, or adipic acid.

It is to be noted that the block copolymer plastic agent may have both of a segment comprising the polyether and a segment comprising the polyester in one molecule, or alternatively, one of a segment comprising the polyether and a segment comprising the polyester. When the block copolymer plastic agent having one of the segments is used for productivity or cost of the plasticizer, use of the block copolymer plastic agent having the segment comprising the polyether is preferable in view of providing the desired formability by adding a smaller amount. In other words, the preferred example of the block copolymer plastic agent is a block copolymer constituted from the segment comprising a polyether and the segment comprising polylactic acid.

Furthermore, the segment comprising a polyether and the segment comprising a polyester in one molecule of the block copolymer plastic agent may have a number average molecular weight of at least 7,000 and up to 20,000. When the number average molecular weight is within such range, the block copolymer plastic agent will be capable of providing sufficient formability-improving effect.

Although no particular limitation is set on the constitutional order of the segment comprising a polyether and/or a polyester and the segment comprising polylactic acid, at least one segment comprising polylactic acid is preferably present at the end of the block copolymer plastic agent in view of effectively suppressing the bleed out.

Next, we describe when polyethylene glycol (polyethylene glycol is hereinafter abbreviated as PEG) having hydroxy group terminal on opposite ends is employed for the segment comprising a polyether.

In commercially available products, the number average molecular weight of the PEG having the hydroxy group terminal at opposite ends (the number average molecular weight of the PEG is hereinafter referred to as M_{PEG}) is normally calculated from the hydroxyl value determined by the neutralization method or the like. In the system having w_{L} % by weight of the lactide added to w_{E} % by weight of the PEG having the hydroxy group terminal at opposite ends, when the lactide is fully reacted with the hydroxy group terminals at opposite ends of the PEG by ring-opening addition polymerization, a copolymer which is substantially PLA-PEG-PLA type block copolymer (wherein PLA represents polylactic acid) can be prepared. If desired, this reaction may be conducted in the co-presence of a catalyst such as tin octylate. Number average molecular weight of the segment comprising the polylactic acid which is one segment of the block copolymer plastic agent can be substantially calculated by: (½)×(w_{L}/w_{E})×M_{PEG}, and weight proportion of the segment component comprising the polylactic acid in relation to the entire block copolymer plastic agent can be substantially calculated by: 100×w_{L}/(w_{L}+w_{E}) %. Furthermore, the weight proportion of the plasticizer component excluding the segment component comprising the polylactic acid in relation to the entire block copolymer plastic agent can be substantially calculated by: 100×w_{E}/(w_{L}+w_{E}) %.

With regard to the aliphatic polyester other than the polylactic acid resin which is an exemplary formability-improving agent, preferable examples include an aliphatic polyester formed from polyglycolic acid, poly(3-hydroxybutylate), poly(3-hydroxybutylate-3-hydroxy valerate), polycaprolactone, or an aliphatic diol such as ethyleneglycol or 1,4-butanediol with an aliphatic dicarboxylic acid such as succinic acid or adipic acid.

With regard to the aliphatic aromatic polyester which is an exemplary formability-improving agent, preferable examples include polybutylene succinate, polybutylene succinate-adipate, and polybutylene adipate-terephthalate.

Of the aliphatic polyesters and aliphatic aromatic polyesters which are formability-improving agents, the preferred for use is at least one member selected from the group consisting of polybutylene adipate-terephthalate, polybutylene succinate, polybutylene succinate-adipate, and poly(3-hydroxy butylate-3-hydroxyvalerate) in view of the significant improvement of formability upon incorporation.

To provide a design with the polylactic acid sheet, a print layer may be formed as the surface layer of the polylactic acid sheet depending on the intended use of the sheet. The print layer is the one formed by printing the desired pattern comprising a letter, figure, symbol, design, or the like. To improve adhesion of the ink used for the print layer with the surface layer of the sheet, the surface may be pretreated by corona treatment, plasma treatment, ozone treatment, frame treatment, or the like in air, nitrogen, or carbon dioxide gas atmosphere. The printing may be accomplished by any printing method known in the art such as gravure printing, offset printing, letterpress printing, screen printing, transfer printing, flexography, and ink jet printing, and the ink used for the printing may be either a water-based ink or a non-water based ink such as solvent ink.

Thickness of the printing layer is not particularly limited. The thickness, however, is preferably 0.1 μm to 10 μm, more preferably 0.2 μm to 3 μm, and still more preferably 0.4 μm to 1 μm in view of the aesthetic appearance of the printing.

Next, a method of producing the polylactic acid sheet wherein layer A and layer B are directly disposed in this order as an example of the method of producing the polylactic acid sheet is described.

Resin compositions which are the starting materials of layer A and layer B are respectively melt extruded into each extruder, and after removal of foreign matters by wire mesh and flow rate adjustment by a gear pump in each extruder, the molten resin is supplied to a multi-manifold nozzle or a feed block above the nozzle. The multi-manifold nozzle or the feed block is preferably provided with the flow path of the desired number and desired shape depending on the necessary film layer constitution. The molten resins ejected from each extruders are brought together as described above at the multi-manifold nozzle or the feed block, and co-extruded in sheet form from the nozzle. The sheet is brought in close contact with the casting drum by an air knife, electrostatic application device, or the like, and solidified by cooling for use as an unstretched sheet.

In this process, a wire mesh of 50 to 400 mesh is preferably used to prevent the surface roughening caused by foreign matters such as gel and thermal degradation products.

The polylactic acid sheet is preferably produced by a method which has a heat treatment step at a temperature of at least 70° C. to improve the heat resistance of the resulting formed body. By conducting a heat treatment of at least 70° C., the polylactic acid sheet can be crystallized. For improvement of sheet heat resistance, a step including the heat treatment is preferably conducted at a temperature of at least 70° C. and up to 210° C., and more preferably at least 75° C. and up to 180° C. As described above, in view of primarily realizing the formability of the polylactic acid sheet, the crystal size of layer A is preferably regulated to at least 1 nm and up to 30 nm, and to regulate the crystal size to this range, the temperature of the heat treatment is most preferably at least 80° C. and up to 150° C. In view of primarily realizing the chemical resistance of the polylactic acid sheet, the crystal size of layer A is preferably regulated to at least 15 nm and up to 40 nm as described above, and to regulate the crystal size to this range, the temperature of the heat treatment is preferably at least 90° C. and up to 175° C., and most preferably at least 130° C. and up to 170° C.

To provide the polylactic acid sheet with sufficient heat resistance, the time of the heat treatment is preferably 5 seconds to 5 minutes and more preferably 5 seconds to 3 minutes. The method used for the heat treatment is not particularly limited, and exemplary preferable methods are those using a heating oven or heating rolls. In the method using the heating oven, the heating is preferably conducted by using hot air, a far-infrared heater, or combination of these.

The polylactic acid sheet may preferably have a haze of less than 5%. When the haze is less than 5%, the formed body produced by using such polylactic acid sheet can be used as a highly designable package container or package sheet with high visibility of its content and aesthetic appearance as a commodity. When the haze is 5% or higher, the transparency may be insufficient for practical use.

In the polylactic acid sheet, the proportion of the stereocomplex crystals in the entire crystals in layer A (hereinafter referred to as Sc proportion) is preferably at least 80%. When the Sc proportion of layer A is at least 80%, haze of the sheet can be reduced to less than 5%, while the Sc proportion of layer A of less than 80%, namely, the increased proportion of the crystals solely comprising the poly-L-lactic acid or the poly-D-lactic acid may invite decrease in the transparency. The Sc proportion of layer A is more preferably at least 85%, and still more preferably at least 88%. To regulate the Sc proportion of layer A to at least 80%, the production process of the sheet having layer A preferably includes a step of heat treatment at a temperature of at least 70° C. and up to 210° C. Preferably, the time of this step of heat treatment to realize the Sc proportion of layer A of at least 80% is at least 30 seconds and up to 5 minutes.

In consideration of simultaneous realization of formability, chemical resistance, transparency, and heat resistance of the polylactic acid sheet, the temperature used in the heat treatment is preferably at least 130° C. and up to 150° C.

The forming method used to obtain the formed article by using the polylactic acid sheet include vacuum forming, vacuum-pressure forming, plug assist forming, straight forming, free drawing forming, plug-and-ring forming, skeleton forming, and various other forming methods. The preliminary heating of the sheet in these methods may be accomplished either by indirect heating or hot plate direct heating. The indirect heating is a method wherein the sheet is preliminarily heated by a heater placed at a position remote from the sheet, and the hot plate direct heating is a method wherein the sheet is preliminarily heated by bringing the sheet in contact with the hot plate. The methods preferable for the polylactic acid resin sheet include vacuum forming and vacuum-pressure forming (indirect forming) and vacuum-pressure forming (hot plate direct heating).

The polylactic acid sheet has excellent formability, transparency, and heat resistance as well as reduced environmental load and, therefore, it is well adapted for various applications including package containers, various electronic and electric appliances, OA equipment, vehicle parts, machine parts, agricultural materials, fishery materials, transportation containers, toys, and miscellaneous goods. Of these, the polylactic acid sheet is most preferably adapted for use in formed food container and lid of beverage cups where formability, transparency, and heat resistance are required.

### Procedure Used to Measure the Physical Properties and Evaluating the Effects

The procedures used to measure the physical properties and evaluating the effects are as described below.

### 1. Layer Thickness Ratio

A sample was cut out from the central part in the transverse direction (hereinafter referred to as TD) of the sheet. By embedding in epoxy resin and using ultramicrotome at −100° C., ultrathin sections were prepared for observation of the cross sectional surface of the sample in the machine direction (hereinafter referred to as MD)—thickness direction. An image of the thin section of the sheet cross section was collected by using a scanning electron microscope at a magnification of 1000 (the magnification may be adequately adjusted) to measure the thickness of each layer. The measurement was repeated 10 times at different locations, and the average of the measurements was used for the thickness (μm) of each layer. The layer thickness ratio of the sheet was calculated from the thickness of each layer.

### 2. Thickness of the Sheet

The thickness was measured for 10 points at an interval of 10 cm in both MD and TD directions by using a Dial gauge thickness meter (JIS B 7503:1997; UPRIGHT DIAL GAUGE (0.001×2 mm) No. 25 manufactured by PEACOCK; flat circle gauge head having a diameter of 5 mm). The average was used for the sheet thickness (μm).

### 3. Measurement of Tensile Modulus (MPa)

Stress-strain measurement was conducted by using TENSILON UCT-100 manufactured by Orientec Co., Ltd. equipped with an incubator tank at 90° C., and a rectangular sample with the length of 150 mm and a width of 10 mm in vertical direction was cut out. The measurement was conducted in an incubator tank adjusted to 90° C. at initial distance between the tensile chucks of 50 mm and a tensile speed of 200 mm/min by the procedure defined in JIS K 7127:1999. By using the first straight line segment of the stress-strain curve, the difference in the stress between two points on the straight line was divided by the difference in the strain between the same two points on the straight line to calculate the tensile modulus. The measurement was conducted 10 times, and the average was used. The value was calculated for both MD and TD directions of the sheet. This tensile modulus is referred to as “modulus” in the Table.

### 4. Preparation of the Formed Body, Evaluation of the Heat Resistance of the Formed Body, and Evaluation of Formability of the Sheet

The sample used was a sheet sample of 320 mm×460 mm (length). Preheating and forming was conducted by using a miniature vacuum former Forming 300X manufactured by Seikosangyo Co., Ltd. having a tray-shaped mold (opening of 150 mm×210 mm, a bottom of 105 mm×196 mm, and a height of 50 mm) under the temperature conditions so that the sheet temperature in the forming was in the range of 100° C. to 200° C.

The resulting formed body was placed in a hot air oven controlled to 100° C. for 5 minutes with the bottom part of the formed body facing upward, and heat resistance of the formed body was evaluated in 5 grades by the degree of height maintenance. The height of the formed body was the height of the bottom part when the formed body was placed with the bottom part facing upward and the formed part was observed from its side. The sheet can be used with no practical problem when the level of the heat resistance is at least 4.

Formability was evaluated by forming a tray-shaped article and checking followability of the sheet to the tray bottom shape and measuring the sheet thickness. The sheet is formable with no practical problem when A or B.

### Heat Resistance of the Formed Body

5: at least 95% and less than 100% of the original height (50 mm)
4: at least 90% and less than 95% of the original height (50 mm)
3: at least 80% and less than 90% of the original height (50 mm)
2: at least 40% and less than 80% of the original height (50 mm)
1: at least 0% and less than 40% of the original height (50 mm)

### Formability of the Sheet

A (very good): the sheet has been formed into the tray-shaped formed body with the sheet fully following the tray bottom shape, and the thickness of the bottom part was at least 30% of the original film thickness.
B (good): the sheet has been formed into the tray-shaped formed body with the sheet fully following the tray bottom shape, and the thickness of the bottom part was less than 30% of the original film thickness.
D (forming failure): the sheet did not fully follow the tray bottom shape, or even if followed, sheet breakage or the like at the tray bottom was confirmed.

### 5. Transparency: Haze Value (%)

Haze value of the sheet was measured by using a haze meter HGM-2DP (manufactured by Suga Test Instruments Co., Ltd.). The measurement was conducted 5 times per sample, and the average of 5 measurements was used for the haze value.

6. Impact Strength: Impact Value (N·m/mm)

The sheet was measured for its impact value by using a film impact tester (manufactured by Toyo Seiki Seisakusho Ltd.) using a semi sphere impact head having a diameter of ½ inch in the atmosphere at a temperature of 23° C. and a humidity of 65%. Sheet samples of 100 mm×100 mm were prepared, and the measurement was conducted 5 times per sample. Furthermore, impact value in each measurement was divided by the thickness of the sample measured to obtain the impact value per unit thickness, and average of 5 measurements was determined. Thickness of the sample was measured with a digital micrometer.

### 7. Molecular Weight

The weight average molecular weight of the polylactic acid resin is the value in terms of standard poly methyl methacrylate measured by gel permeation chromatography (GPC). The GPC was measured by using differential refractometer WATERS410 manufactured by WATAERS for the detector, MODEL 510 manufactured by WATAERS for the pump, and serially connected Shodex GPC HFIP-806M and Shodex GPC HFIP-LG for the column. The measurement was conducted under the conditions of flow rate at 0.5 ml/min using hexafluoroisopropanol for the solvent and injecting 0.1 ml of the solution at a sample concentration of 1 mg/mL.

### 8. Melting Point

The melting point of the polylactic acid resin was measured by using a differential scanning colorimeter (DSC) manufactured by PerkinElmer under the conditions including sample of 5 mg, nitrogen atmosphere, temperature elevation speed of 20° C./min., and temperature reduction speed of 20° C./min. The “melting point” is the peak top temperature in the crystal melting peak.

More specifically, the melting point is the one measured by conducting a first heating step by elevating temperature from 30° C. to 250° C. at a temperature elevation speed of 20° C./min and reducing the temperature to 30° C. at a temperature reducing speed of 20° C./min, and then conducting a second heating step by elevating temperature from 30° C. to 250° C. at a temperature elevation speed of 20° C./min, and measuring the melting point during this temperature elevation.

### 9. Degree of Surface Orientation ΔP (Determination of Orientation State)

Orientation state of the polylactic acid sheet was determined by the value of the degree of surface orientation ΔP.

Birefringence Δx, Δy, and Δz for 3 principal axis directions of the sheet sample were evaluated by automatic birefringence analyzer KOBRA-21ADH manufactured by Oji Scientific Instruments, and the surface orientation ΔP was determined by the following equation:

ΔP={(γ+β)/2}−α=(Δy−Δz)/2

from the relations of Δx=y−β, Δy=γ−α, Δz=α−β (wherein γ≧β, and α is the refractive index in the thickness direction of the sheet).
Oriented: the degree of surface orientation ΔP is in excess of 0.002
Non-oriented: the degree of surface orientation ΔP is at least 0 and up to 0.002.

### 10. Degree of Crystallinity (%) of Layer A, Crystal Size (nm) of Layer A, Sc Proportion (%) of Layer A

When the polylactic acid sheet is a single layer sheet comprising layer A, the procedure used for measuring the degree of crystallinity (%) of layer A, the crystal size (nm) of layer A, and the Sc proportion (%) of layer A are as described below.

A sample was cut out of the polylactic acid sheet so that the plane measured in the X-ray diffractometry is the surface in MD-TD directions. This sample piece was placed on sample holder of the X-ray diffractometer (D8 ADVANCE manufactured by Bruker AXS). For the diffraction peak obtained by wide angle X-ray diffractometry (2θ−θ scanning) using this X-ray diffractometer, total area (Sₜₒₜₐₗ) corresponding to the 2θ of 10 to 30 degrees was determined by using the diffraction curve obtained for the amorphous part for the base line, and the area of the diffraction curve of the amorphous part was also determined. The degree of crystallinity (%) of layer A was then calculated by the following equation:

Degree of crystallinity of layer A=Sₜₒₜₐₗ/(Sₜₒₜₐₗ+area of the diffraction curve of the amorphous part)×100.

In addition, the crystal size of layer A was determined from half width of the peak near the 2θ of 12 degrees by the following equation:

The crystal size of layer A=0.15418/[{(half width)²−(apparatus constant)²}^{0.5}×cos θ]

(0.13 degrees was used for the apparatus constant).

Sum (Ssc) of the diffraction peak areas near 12 degrees, 21 degrees, and 24 degrees corresponding to the stereocrystal was also determined, and the Sc proportion of layer A was calculated by the following equation:

Sc proportion of layer A=Ssc×100/Sₜₒₜₐₗ.

The measurement was conducted under the following conditions:
X ray source: CuKα ray
Output: 40 kV, 40 mA
Slit diameter: DS=SS=1 degree, RS=0.6 mm, RSm=1 mm
Detector: scintillation counter
Measurement range: 5 to 80 degrees
Step width (2θ): 0.05 degree
Scan speed: 1 degree/min.

Next, when the polylactic acid sheet is a laminate, the procedure used for measuring the degree of crystallinity (%) of layer A, the crystal size (nm) of layer A, and the Sc proportion (%) of layer A are as described below.

A sample was cut out from the central part in the TD direction of the polylactic acid sheet. By embedding in epoxy resin and using ultramicrotome, the sample for X-ray diffractometry was collected at −100° C. for observation of the cross sectional surface of the sample piece in the MD direction and the thickness direction, and the sheet sample was placed on sample holder of the X-ray diffractometer (D8 DISCOVER manufactured by Bruker AXS). To measure the degree of crystallinity (%) of layer A and the crystal size of layer A by wide angle X-ray diffractometry (micro-X-ray diffractometry), the cross-section of layer A was irradiated with X-ray irradiation beam (CuKα ray) in MD direction to measure the diffraction peak. For the thus obtained diffraction peak, the diffraction curve obtained for the amorphous part was excluded from the entire diffraction curve to determine the total area (Sₜₒₜₐₗ) corresponding to the 20 of 10 to 30 degrees as well as area of the diffraction curve corresponding to the amorphous parts. The degree of crystallinity (%) of layer A was then calculated by the following equation:

Degree of crystallinity of layer A=Sₜₒₜₐₗ/(Sₜₒₜₐₗ+area of the diffraction curve of the amorphous part)×100.

In addition, the crystal size of layer A was determined from half width of the peak near the 20 of 12 degrees (diffraction of 100 face of the stereocomplex) by the following equation:

The crystal size of layer A=0.15418/[{(half width)²−(apparatus constant)²}^{0.5}×cos θ]

(half width of the diffraction peak of 111 face of the Si was used for the apparatus constant).

Sum (Ssc) of the diffraction peak areas near 12 degrees, 21 degrees, and 24 degrees corresponding to the stereocrystal was also determined, and the Sc proportion of layer A was calculated by the following equation:

Sc proportion of layer A=Ssc×100/Sₜₒₜₐₗ.

The measurement was conducted under the following conditions:
X ray source: CuKα ray
Output: 50 kV, 22 mA
Beam diameter: 0.04 mm
Range of measurement: 5 to 70 degrees.

### 11. Chemical Resistance

Chemical resistance of the sheet was evaluated by storing the sheet in the solvent indicted in the table (toluene, acetone, ethanol, methyl ethyl ketone, or ethyl acetate) in the environment of 25° C., and evaluating the difference between the haze value before the storage and the haze value after the storage. Smaller difference in the haze value corresponds to the higher chemical resistance, and “A” and “B” are practically acceptable.

The difference in the haze values was calculated by the following equation:

Difference in the haze values=(the haze value before storing in the solvent)−(the haze value after storing in the solvent)
A: difference in the haze values was at least 0 and less than 10,
B: difference in the haze values was at least 10 and less than 20,
C: difference in the haze values was at least 20.

### EXAMPLES

The materials used in the Production Examples, Examples, and Comparative Examples are as described below. It is to be noted that the abbreviations as described below may be used in the Production Examples, Examples, and Comparative Examples:
A-1: Production Example 1 (a mixture of poly-L-lactic acid and poly-D-lactic acid having a weight average molecular weight of 182,000 and a melting point of 214° C.)
A-2: Production Example 2 (a polylactic acid block copolymer constituted from a segment comprising poly-L-lactic acid and a segment comprising poly-D-lactic acid having a weight average molecular weight of 166,000 and a melting point of 213° C.)
A-3: Production Example 3 (a polylactic acid block copolymer constituted from a segment comprising poly-L-lactic acid and a segment comprising poly-D-lactic acid having a weight average molecular weight of 143,000 and a melting point of 210° C.)
B-1: A polylactic acid resin which has been dried in a rotary vacuum dryer at 50° C. for 8 hours (“Ingeo” 4060D manufactured by Nature Works having a D-isomer content of 12% by mole, a Tg of 58° C., and no melting point)
B-2: A polylactic acid resin which has been dried in a rotary vacuum dryer at 100° C. for 5 hours (“Ingeo” 4032D manufactured by Nature Works having a D-isomer content of 1.4% by mole, a Tg of 58° C., and a melting point of 166° C.)
C-1: Production Example 3 (a polyether block copolymer constituted from a segment comprising a PLA-PEG-PLA-type polyether and a segment comprising polylactic acid)
C-2: a polymer having a multi-layer constitution constituted from a core layer and a shell layer covering the core layer (a core-shell type acryl polymer) (product name: “PARALOID BPM500” manufactured by Rohm and Hass Japan) (core layer, butyl acrylate polymer; shell layer, methyl methacrylate polymer)
C-3: polybutylene succinate (product name: “GsPla FZ71PD” manufactured by Mitsubishi Chemical Corporation).

### Production Example 1

### Production Example of A-1

50% by weight of 90% by weight aqueous solution of L-lactic acid was placed in a reaction vessel equipped with an agitator and a reflux device, and after elevating temperature to 150° C., the reaction was allowed to continue for 3.5 hours while gradually reducing the pressure and distilling off the water. The pressure was then brought to normal pressure in nitrogen atmosphere, and 0.02% by weight of tin acetate (II) was added. The pressure was gradually reduced to 13 Pa at 170° C., and polymerization reaction was allowed to take place for 7 hours to obtain a poly-L-lactic acid (PLLA1). The PLLA1 had a weight average molecular weight of 18,000, a melting point of 149° C., and a melt ending temperature of 163° C.

The resulting PLLA1 was subjected to crystallization treatment in nitrogen atmosphere at 110° C. for 1 hour, and solid phase polymerization was conducted at a pressure of 60 Pa and at 140° C. for 3 hours, at 150° C. for 3 hours, and at 160° C. for 18 hours to obtain a poly-L-lactic acid (PLLA2). The PLLA2 had a weight average molecular weight of 203,000 and a melting point of 170° C.

Next, 50% by weight of 90% by weight aqueous solution of D-lactic acid was placed in a reaction vessel equipped with an agitator and a reflux device, and after elevating temperature to 150° C., the reaction was allowed to continue for 3.5 hours while gradually reducing the pressure and distilling off the water. The pressure was then brought to normal pressure in nitrogen atmosphere, and 0.02% by weight of tin acetate (II) was added. The pressure was gradually reduced to 13 Pa at 170° C., and polymerization reaction was allowed to take place for 7 hours to obtain a poly-D-lactic acid (PDLA1). The PDLA1 had a weight average molecular weight of 17,000, a melting point of 148° C., and a melt ending temperature of 161° C.

The resulting PDLA1 was subjected to crystallization treatment in a nitrogen atmosphere at 110° C. for 1 hour, and solid phase polymerization was conducted at a pressure of 60 Pa and at 140° C. for 3 hours, at 150° C. for 3 hours, and at 160° C. for 14 hours to obtain a poly-L-lactic acid (PDLA2). The PDLA2 had a weight average molecular weight of 158,000 and a melting point of 168° C.

Next, after preliminarily crystallizing PLLA2 and PDLA2 in nitrogen atmosphere at a temperature of 110° C. for 2 hours, the starting materials were blended at PLLA2/PDLA2 of 50/50% by weight. After dry blending 0.5% by weight of catalyst deactivator (“ADEKASTAB” AX-71 manufactured by ADEKA) in relation to 100% by weight of the total of the PLLA2 and the PDLA2, melt kneading was conducted in PCM30 biaxial extruder having 2 kneading blocks having the cylinder temperature regulated to 240° C. and screw rotation speed to 100 rpm. The strand ejected from the dyes was cooled in a cooling bath and pelletized in a strand cutter to obtain pelletized polylactic acid resin A-1.

Polylactic acid resin A-1 had a weight average molecular weight of 182,000 and a melting point of 214° C. The resulting A-1 was subjected to crystallization treatment at a pressure of 13.3 Pa and a temperature of 110° C. for 2 hours.

### Production Example 2

### Production Example of A-2

A-2 was produced by the step of mixing the poly-L-lactic acid and the poly-D-lactic acid in the biaxial extruder to produce a mixture, and conducting the solid phase polymerization of the mixture to produce the polylactic acid block copolymer as described above. More specifically, after crystallizing the PDLA1 obtained in the Production Example 1 in nitrogen atmosphere at 110° C. for 1 hour, solid phase polymerization was conducted at a pressure of 60 Pa at 140° C. for 3 hours, at 150° C. for 3 hour, and at 160° C. for 6 hours to thereby obtain poly-D-lactic acid (PDLA3). The PDLA3 had a weight average molecular weight of 42,000 and a melting point of 158° C.

The PLLA2 and the PDLA3 obtained in Production Example 1 was preliminarily subjected to crystallization treatment in a nitrogen atmosphere at a temperature of 110° C. for 2 hours. The PLLA2 was supplied to TEX30α biaxial extruder (manufactured by THE JAPAN STEEL WORKS, LTD.) from its resin inlet and the PDLA3 was supplied from the side inlet provided at L/D of 30 for melt kneading. The biaxial extruder has a plasticizing section at L/D of 10 from the resin inlet with the temperature regulated to 180° C. and a kneading disk at L/D of 30 with a shearing screw. In other words, the biaxial extruder has a structure that allows the mixing to be conducted with shearing. The mixing of the PLLA2 and the PDLA3 was conducted at a mixing temperature of 200° C. with shearing. The strand ejected from the dyes was cooled in a cooling bath and pelletized in a strand cutter to obtain pelletized polylactic acid melt kneaded resin. The resulting polylactic acid melt kneaded resin was dried in a vacuum dryer at 110° C. and at a pressure of 13.3 Pa for 2 hours. Solid phase polymerization was conducted at 140° C. at a pressure of 13.3 Pa for 4 hours, and another 4 hours after elevating the temperature to 150° C., and another 10 hours after elevating the temperature to 160° C. to thereby obtain the polylactic acid block copolymer. After dry blending 0.5% by weight of catalyst deactivator (“ADEKASTAB” AX-71 manufactured by ADEKA) in relation to 100% by weight of the resulting polylactic acid block copolymer, melt kneading was conducted in PCM30 biaxial extruder having 2 kneading blocks having the cylinder temperature regulated to 240° C. and screw rotation speed to 100 rpm. The strand ejected from the dyes was cooled in a cooling bath and pelletized in a strand cutter to obtain pelletized polylactic acid resin A-2. Polylactic acid resin A-2 had a weight average molecular weight of 166,000 and a melting point of 213° C. The crystallization treatment was conducted at a pressure of 13.3 Pa and temperature of 110° C. for 2 hours.

### Production Example 3

### Production Example of A-3

PDLA4 having a weight average molecular weight of 8,000 was prepared by repeating the procedure of producing the PDLA1 in Production Example 1 except that the temperature, the pressure, and the polymerization time were changed. The polylactic acid block copolymer (A-3) was prepared by using the conditions of Production Example 2 except the PDLA4 was used instead of PDLA3 in the Production Example 2. Polylactic acid resin A-3 had a weight average molecular weight of 143,000 and a melting point of 210° C. The crystallization treatment was conducted at a pressure of 13.3 Pa and temperature of 110° C. for 2 hours.

### Production Example 4

### Production Example of C-1

62% by weight of polyethylene glycol having a number average molecular weight of 8,000, 38% by weight of L-lactide, and 0.05% by weight of tin octylate were mixed, and the mixture was polymerized in a reaction vessel equipped with an agitator in a nitrogen atmosphere at 160° C. for 3 hours to produce a PLA-PEG-PLA block copolymer B-1 comprising a polyethylene glycol having a number average molecular weight of 8,000 having polylactic acid segments each having a number average molecular weight of 2,500 on opposite ends of the polyethylene glycol. The drying was conducted in a rotary vacuum dryer at 80° C. for 5 hours.

### Example 1

100% by weight of A-2 (the resin composition for layer A) was extruded at 230° C. to a vented extruder (A) while melt kneading the polymer with deaeration of the vacuum vent section, and after filtering the polymer through a wire mesh (100 mesh), the polymer was supplied to a two-resin-three-layer type multi-manifold nozzle. In the meanwhile, 100% by weight of B-1 was extruded at 220° C. to a vented extruder (B) while melt kneading the polymer with deaeration of the vacuum vent section, and after filtering the polymer through a wire mesh (100 mesh) in a flow path different from the extruder (A), co-extrusion was conducted from a T-die nozzle set at a nozzle temperature of 230° C. into a space between the pair of a casting drum and a polishing roll which rotates in the contacting direction and which are cooled to 40° C. After cooling and solidification by the close contact with the casting drum, the thus produced unstretched sheet was taken up by a winder.

The resulting sheet had a thickness of 250 μm, and the thickness constitution was layer A/layer B/layer A of 2/6/2. The sheet was subjected to a heat treatment in a hot air oven at a heat treatment temperature of 90° C. for 20 seconds. By using the resulting sheet, a formed body was prepared by the procedure described in the section of the formed body production of the “The procedure used to measure the physical properties and evaluating the effects.”

The properties of the resulting sheets and formed bodies are as shown in Table 1, and they exhibited excellent transparency, impact strength, and formability.

### Examples 2 to 18 and Comparative Examples 1 to 2

Examples 2 to 18 and Comparative Examples 1 to 2 were conducted by repeating the procedure of Example 1 except for the sheet composition, the heat treatment temperature (° C.), and the heat treatment time (second) were changed to those shown in the Tables. Physical properties of the thus obtained sheets and formed bodies are shown in the Tables.

### Examples 19 to 26

Examples 19 to 26 were conducted by repeating the procedure of Example 1 except that 100% by weight of A-2 was extruded both from the vented extruder (A) and the vented extruder (B) as the resin composition, and the heat treatment temperature (° C.) and the heat treatment time (second) were changed to those shown in the Table to obtain a sheet and a formed body solely comprising layer A. Physical properties of the thus obtained sheets are shown in Table 3. In all of the Examples 19 to 26, the layer thickness ratio of layer A was such that layer A/layer A/layer A=2/6/2.

### Comparative Example 3

100% by weight of A-1 (the resin composition for layer A) was extruded at 230° C. to a vented extruder (A) while melt kneading the polymer with deaeration of the vacuum vent section, and after filtering the polymer through a wire mesh (100 mesh), the polymer was supplied to a two-resin-three-layer type multi-manifold nozzle. In the meanwhile, 100% by weight of B-2 was extruded at 220° C. to a vented extruder (B) while melt kneading the polymer with deaeration of the vacuum vent section, and after filtering the polymer through a wire mesh (100 mesh) in a flow path different from the extruder (A), co-extrusion was conducted from a T-die nozzle set at a nozzle temperature of 230° C. into a space between the pair of a casting drum and a polishing roll which rotate in the contacting direction and which are cooled to 40° C. The extruded sheet was cooled and solidified by the close contact with the casting drum.

The thus obtained unstretched sheet was stretched 3 times in machine direction by using a roll stretcher at 70° C., and the stretched sheet was immediately cooled to room temperature. Next, the resulting monoaxially stretched film was guided to a tenter and stretched 3.2 times in transverse direction at 90° C. with opposite edges held by clips. After heat setting at 195° C. and cooling, the stretched film was taken up. The resulting sheet was 250 μm thick and the thickness constitution was a layer A/layer B/layer A of 2/6/2. This sheet was subjected to a heat treatment in a hot air oven at a heat treatment temperature of 90° C. for 20 seconds. The resulting sheet and formed body had characteristic values as shown in the Tables, and due to the biaxial stretching, the sheet had been oriented. Because of the high rigidity of the resulting sheet, the attempt of producing the formed body failed due to the failure in the forming.

TABLE 1

| | | Ex. 1 | Ex. 2 | Ex. 3 | Ex. 4 | Ex. 5 | Ex. 6 |
|---|---|---|---|---|---|---|---|
| Layer A (wt %) | | A-2(100) | A-2(100) | A-2(100) | A-2(100) | A-2(100) | A-1(100) |
| Layer B (wt %) | | B-1(100) | B-1(100) | B-1(70) | B-1(60) | B-2(100) | B-1(100) |
| | | | | B-2(30) | B-2(40) | | |
| Sheet orientation | | No | No | No | No | No | No |
| Layer thickness ratio | | A/B/A | A/B/A | A/B/A | A/B/A | A/B/A | A/B/A |
| | | (2/6/2) | (1/8/1) | (2/6/2) | (2/6/2) | (2/6/2) | (2/6/2) |
| Heat treatment temperature (° C.) | | 90 | 90 | 90 | 90 | 90 | 90 |
| Heat treatment time (sec) | | 20 | 20 | 20 | 20 | 20 | 20 |
| Thickness (μm) | | 250 | 250 | 250 | 250 | 250 | 250 |
| Note | | — | — | — | — | — | — |
| Sheet | Degree of surface orientation: ΔP | 0.0003 | 0.0004 | 0.0004 | 0.0004 | 0.0008 | 0.0004 |
| | Haze (%) | 2 | 2 | 3.2 | 3.5 | 4.3 | 3.6 |
| | Impact (N · m/mm) | 1.5 | 1.5 | 1.3 | 1.2 | 1.1 | 1.4 |
| | Modulus (MPA) MD/TD | 40/37 | 30/26 | 50/48 | 60/55 | 68/63 | 43/37 |
| | Formability | A | A | A | A | A | A |
| Formed body | Heat resistance | 4 | 4 | 4 | 5 | 5 | 4 |
| | | Ex. 7 | Ex. 8 | Ex. 9 | Ex. 10 | Ex. 11 | Ex. 12 |
| Layer A (wt %) | | A-1(100) | A-3(100) | A-2(100) | A-2(100) | A-2(100) | A-2(90) |
| | | | | | | | C-1(10) |
| Layer B (wt %) | | B-2(100) | B-1(100) | B-1(90) | B-1(90) | B-1(90) | B-1(100) |
| | | | | C-1(10) | C-2(10) | C-3(10) | |
| Sheet orientation | | No | No | No | No | No | No |
| Layer thickness ratio | | A/B/A | A/B/A | A/B/A | A/B/A | A/B/A | A/B/A |
| | | (2/6/2) | (2/6/2) | (2/6/2) | (2/6/2) | (2/6/2) | (2/6/2) |
| Heat treatment temperature (° C.) | | 90 | 90 | 90 | 90 | 90 | 90 |
| Heat treatment time (sec) | | 20 | 20 | 20 | 20 | 20 | 20 |
| Thickness (μm) | | 250 | 250 | 250 | 250 | 250 | 250 |
| Note | | — | — | — | — | — | — |
| Sheet | Degree of surface orientation: ΔP | 0.0007 | 0.0004 | 0.0004 | 0.0003 | 0.0004 | 0.0003 |
| | Haze (%) | 4.9 | 4.8 | 3 | 3.2 | 3.9 | 3.5 |
| | Impact (N · m/mm) | 1 | 0.9 | 3 | 3 | 2.8 | 3.2 |
| | Modulus (MPA) MD/TD | 55/50 | 28/25 | 33/31 | 30/26 | 36/33 | 31/29 |
| | Formability | B | B | A | A | A | A |
| Formed body | Heat resistance | 4 | 4 | 4 | 4 | 4 | 4 |

TABLE 2

| | | Ex. 13 | Ex. 14 | Ex. 15 | Ex. 16 | Ex. 17 |
|---|---|---|---|---|---|---|
| Layer A (wt %) | | A-2(90) | A-2(90) | A-2(100) | A-2(100) | A-2(100) |
| | | C-2(10) | C-3(10) | | | |
| Layer B (wt %) | | B-1(100) | B-1(100) | B-1(100) | B-1(100) | B-1(100) |
| Sheet orientation | | No | No | No | No | No |
| Layer thickness ratio | | A/B/A | A/B/A | A/B/A | A/B/A | A/B/A |
| | | (2/6/2) | (2/6/2) | (2/6/2) | (2/6/2) | (2/6/2) |
| Heat treatment temperature (° C.) | | 90 | 90 | No heat treatment | 100 | 120 |
| Heat treatment time (sec) | | 20 | 20 | 20 | 20 | 20 |
| Thickness (μm) | | 250 | 250 | 250 | 250 | 250 |
| Note | | — | — | — | — | — |
| Sheet | Degree of surface orientation: ΔP | 0.0004 | 0.0004 | 0.0004 | 0.0004 | 0.0005 |
| | Haze (%) | 3.7 | 4.2 | 1.7 | 1.8 | 2 |
| | Impact (N · m/mm) | 3.4 | 3 | 1.5 | 1.5 | 1.4 |
| | Modulus (MPA) MD/TD | 27/25 | 37/35 | 32/30 | 70/67 | 76/75 |
| | Formability | A | A | A | B | B |
| Formed body | Heat resistance | 4 | 4 | 4 | 5 | 5 |

| | | Ex. 18 | Comp. Ex. 1 | Comp. Ex. 2 | Comp. Ex. 3 |
|---|---|---|---|---|---|
| Layer A (wt %) | | A-2(100) | B-1(100) | B-2(100) | A-2(100) |
| Layer B (wt %) | | B-1(100) | B-1(100) | B-2(100) | B-2(100) |
| Sheet orientation | | No | No | No | Yes |
| Layer thickness ratio | | A/B/A | Single film | Single film | A/B/A |
| | | (2/6/2) | (2/6/2) | (2/6/2) | (2/6/2) |
| Heat treatment temperature (° C.) | | 150 | 90 | 90 | 90 |
| Heat treatment time (sec) | | 20 | 20 | 20 | 20 |
| Thickness (μm) | | 250 | 250 | 250 | 250 |
| Note | | — | — | — | * |
| Sheet | Degree of surface orientation: ΔP | 0.0006 | 0.0004 | 0.0008 | 0.0189 |
| | Haze (%) | 2.6 | 1.5 | 1.6 | 3.6 |
| | Impact (N · m/mm) | 1.3 | 1.8 | 1.7 | 3.2 |
| | Modulus (MPA) MD/TD | 88/80 | 5/4 | 7/6 | 153/149 |
| | Formability | B | A | A | — |
| Formed body | Heat resistance | 5 | 1 | 1 | — |

* The sheet was biaxially stretched. The resulting sheet exhibited forming failure.

TABLE 3

| | | | Ex. 19 | Ex. 20 | Ex. 21 | Ex. 22 | Ex. 23 | Ex. 24 | Ex. 25 | Ex. 26 |
|---|---|---|---|---|---|---|---|---|---|---|
| Layer A (wt %) | | | A-2(100) | A-2(100) | A-2(100) | A-2(100) | A-2(100) | A-2(100) | A-2(100) | A-2(100) |
| Layer B (wt %) | | | — | — | — | — | — | — | — | — |
| Sheet orientation | | | No | No | No | No | No | No | No | No |
| Layer thickness ratio | | | — | — | — | — | — | — | — | — |
| Heat treatment temperature (° C.) | | | 120 | 150 | 150 | 85 | 100 | 135 | 170 | 190 |
| Heat treatment time (sec) | | | 60 | 30 | 60 | 60 | 60 | 60 | 60 | 60 |
| Thickness (μm) | | | 250 | 250 | 250 | 250 | 250 | 250 | 250 | 250 |
| Note | | | — | — | — | — | — | — | — | — |
| Sheet | Degree of surface orientation: ΔP | | 0.0008 | 0.0009 | 0.0009 | 0.0008 | 0.0009 | 0.0009 | 0.0009 | 0.0009 |
| | Haze (%) | | 3.8 | 3.9 | 4 | 3.7 | 3.8 | 3.8 | 4.1 | 4.3 |
| | Impact (N · m/mm) | | 0.8 | 0.8 | 0.8 | 0.8 | 0.8 | 0.8 | 0.8 | 0.8 |
| | Modulus (MPA) MD/TD | | 120/115 | 140/133 | 140/133 | 109/98 | 115/110 | 135/131 | 144/138 | 152/143 |
| | Degree of crystallinity of layer A (%) | | 11 | 12 | 16 | 10 | 11 | 12 | 17 | 17 |
| | Crystal size (nm) of layer A | | 16 | 23 | 25 | 14 | 15 | 22 | 32 | 48 |
| | Sc proportion (%) of layer A | | 95 | 88 | 85 | 99 | 99 | 96 | 88 | 95 |
| | Formablity | | B | B | B | B | B | B | D | D |
| | Chemical resistance | Toluene | B | A | A | C | B | A | A | C |
| | | Acetone | B | A | A | C | B | A | A | C |
| | | Ethanol | A | A | A | A | A | A | A | A |
| | | Methyl ethyl | B | A | A | C | B | A | A | C |
| | | ketone | | | | | | | | |
| | | Ethyl acetate | B | A | A | C | B | A | A | C |

| | | | | | | | | | |
|---|---|---|---|---|---|---|---|---|---|
| Formed body | Heat resistance | 5 | 5 | 5 | 5 | 5 | 5 | 5 | 5 |

### INDUSTRIAL APPLICABILITY

A polylactic acid sheet has excellent formability, transparency and heat resistance, and the polylactic acid sheet is well adapted for use as wrapping materials for food applications as well as various industrial materials.

1-9. (canceled)

10. A polylactic acid sheet comprising a layer A mainly comprising a polylactic acid resin A as a main constituent of the layer A, wherein
the polylactic acid resin A has a melting point when measured under Condition 1 of at least 190° C. and up to 230° C., and
the polylactic acid resin A is non-oriented;
Condition 1: in a measurement by DSC, a first heating step is conducted by elevating temperature from 30° C. to 250° C. at a temperature elevation speed of 20° C./min and reducing the temperature to 30° C. at a temperature reducing speed of 20° C./min, a second heating step is conducted by elevating temperature from 30° C. to 250° C. at a temperature elevation speed of 20° C./min, and the melting point is measured during this temperature elevation.

11. The polylactic acid sheet according to claim 10, wherein the polylactic acid resin A is a polylactic acid block copolymer constituted of a segment comprising a poly-L-lactic acid and a segment comprising a poly-D-lactic acid.

12. The polylactic acid sheet according to claim 11, wherein the segment comprising the poly-L-lactic acid and the segment comprising the poly-D-lactic acid in the polylactic acid block copolymer are such that one segment has a weight average molecular weight of at least 60,000 to up to 300,000 and the other segment has a weight average molecular weight of at least 10,000 and up to 100,000.

13. The polylactic acid sheet according to claim 10, wherein layer A has a degree of crystallinity of at least 1% and up to 30% and a crystal size of at least 1 nm and up to 40 nm.

14. The polylactic acid sheet according to claim 10, further comprising a layer B mainly comprising a polylactic acid resin B as a main constituent of the layer B, wherein
the polylactic acid resin B has a melting point when measured under Condition 1 of less than 185° C. or no melting point:
Condition 1: in a measurement by DSC, a first heating step is conducted by elevating temperature from 30° C. to 250° C. at a temperature elevation speed of 20° C./min and reducing the temperature to 30° C. at a temperature reducing speed of 20° C./min, a second heating step is conducted by elevating temperature from 30° C. to 250° C. at a temperature elevation speed of 20° C./min, and the melting point is measured during this temperature elevation.

15. The polylactic acid sheet according to claim 14, wherein the layer A and the layer B are directly laminated with no intervening layer.

16. The polylactic acid sheet according to claim 10, wherein the polylactic acid sheet contains at least one member selected from the group consisting of a polymer having a multi-layer structure comprising a core layer and at least one shell layer covering the core layer; a polyether block copolymer constituted of a segment comprising a polyether and a segment comprising a polylactic acid; a polyester block copolymer constituted of a segment comprising a polyester and a segment comprising a polylactic acid; an aliphatic polyester other than the polylactic acid resin; and an aliphatic aromatic polyester.

17. A method of producing the polylactic acid sheet of claim 11 comprising:
mixing a poly-L-lactic acid and a poly-D-lactic acid in a biaxial extruder to prepare a mixture;
preparing the polylactic acid block copolymer by solid phase polymerization of the mixture; and
producing the layer A from the polylactic acid block copolymer.

18. The method of claim 11, further comprising conducting a heat treatment at a temperature of at least 70° C.

19. The polylactic acid sheet according to claim 11, wherein layer A has a degree of crystallinity of at least 1% and up to 30% and a crystal size of at least 1 nm and up to 40 nm.

20. The polylactic acid sheet according to claim 12, wherein layer A has a degree of crystallinity of at least 1% and up to 30% and a crystal size of at least 1 nm and up to 40 nm.

21. The polylactic acid sheet according to claim 11, further comprising a layer B mainly comprising a polylactic acid resin B as a main constituent of the layer B, wherein
the polylactic acid resin B has a melting point when measured under Condition 1 of less than 185° C. or no melting point:
Condition 1: in a measurement by DSC, a first heating step is conducted by elevating temperature from 30° C. to 250° C. at a temperature elevation speed of 20° C./min and reducing the temperature to 30° C. at a temperature reducing speed of 20° C./min, a second heating step is conducted by elevating temperature from 30° C. to 250° C. at a temperature elevation speed of 20° C./min, and the melting point is measured during this temperature elevation.

22. The polylactic acid sheet according to claim 12, further comprising a layer B mainly comprising a polylactic acid resin B as a main constituent of the layer B, wherein
the polylactic acid resin B has a melting point when measured under Condition 1 of less than 185° C. or no melting point:
Condition 1: in a measurement by DSC, a first heating step is conducted by elevating temperature from 30° C. to 250° C. at a temperature elevation speed of 20° C./min and reducing the temperature to 30° C. at a temperature reducing speed of 20° C./min, a second heating step is conducted by elevating temperature from 30° C. to 250° C. at a temperature elevation speed of 20° C./min, and the melting point is measured during this temperature elevation.

23. The polylactic acid sheet according to claim 13, further comprising a layer B mainly comprising a polylactic acid resin B as a main constituent of the layer B, wherein
the polylactic acid resin B has a melting point when measured under Condition 1 of less than 185° C. or no melting point:
Condition 1: in a measurement by DSC, a first heating step is conducted by elevating temperature from 30° C. to 250° C. at a temperature elevation speed of 20° C./min and reducing the temperature to 30° C. at a temperature reducing speed of 20° C./min, a second heating step is conducted by elevating temperature from 30° C. to 250° C. at a temperature elevation speed of 20° C./min, and the melting point is measured during this temperature elevation.

24. The polylactic acid sheet according to claim 11, wherein the polylactic acid sheet contains at least one member selected from the group consisting of a polymer having a multi-layer structure comprising a core layer and at least one shell layer covering the core layer; a polyether block copolymer constituted of a segment comprising a polyether and a segment comprising a polylactic acid; a polyester block copolymer constituted of a segment comprising a polyester and a segment comprising a polylactic acid; an aliphatic polyester other than the polylactic acid resin; and an aliphatic aromatic polyester.

25. The polylactic acid sheet according to claim 12, wherein the polylactic acid sheet contains at least one member selected from the group consisting of a polymer having a multi-layer structure comprising a core layer and at least one shell layer covering the core layer; a polyether block copolymer constituted of a segment comprising a polyether and a segment comprising a polylactic acid; a polyester block copolymer constituted of a segment comprising a polyester and a segment comprising a polylactic acid; an aliphatic polyester other than the polylactic acid resin; and an aliphatic aromatic polyester.

26. The polylactic acid sheet according to claim 13, wherein the polylactic acid sheet contains at least one member selected from the group consisting of a polymer having a multi-layer structure comprising a core layer and at least one shell layer covering the core layer; a polyether block copolymer constituted of a segment comprising a polyether and a segment comprising a polylactic acid; a polyester block copolymer constituted of a segment comprising a polyester and a segment comprising a polylactic acid; an aliphatic polyester other than the polylactic acid resin; and an aliphatic aromatic polyester.

27. The polylactic acid sheet according to claim 14, wherein the polylactic acid sheet contains at least one member selected from the group consisting of a polymer having a multi-layer structure comprising a core layer and at least one shell layer covering the core layer; a polyether block copolymer constituted of a segment comprising a polyether and a segment comprising a polylactic acid; a polyester block copolymer constituted of a segment comprising a polyester and a segment comprising a polylactic acid; an aliphatic polyester other than the polylactic acid resin; and an aliphatic aromatic polyester.

28. The polylactic acid sheet according to claim 15, wherein the polylactic acid sheet contains at least one member selected from the group consisting of a polymer having a multi-layer structure comprising a core layer and at least one shell layer covering the core layer; a polyether block copolymer constituted of a segment comprising a polyether and a segment comprising a polylactic acid; a polyester block copolymer constituted of a segment comprising a polyester and a segment comprising a polylactic acid; an aliphatic polyester other than the polylactic acid resin; and an aliphatic aromatic polyester.
